(19) United States
(12) Patent Application Publication
(10) Pub. No.: US 2010/0170764 A1
(43) Pub. Date: Jul. 8, 2010

(54) AUTOMATIC TRANSMISSION

(75) Inventors: Terasu Harashima, Toyota-shi (JP); Kazunori Kaneko, Toyota-shi (JP); Tetsuya Kohno, Okazaki-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/684,295

(22) Filed: Jan. 8, 2010

(30) Foreign Application Priority Data
Jan. 8, 2009 (JP) JP2009-002491

(51) Int. Cl. F16D 13/74

(52) U.S. Cl. 192/70.12

(57) ABSTRACT

An automatic transmission includes a clutch, a clutch drum, a piston, and a brake. The clutch drum, the clutch, and the brake are arranged in sequence in an interior space formed by joining a transmission case to a rear case in an axial direction from the rear case side. A separating/guiding wall that is provided in a circumferential direction so as to define a surplus lubricating oil trapping space for trapping surplus lubricating oil that gathers on an inner peripheral surface of the transmission case and in a second brake, and causes trapped surplus lubricating oil guided thereby into the surplus lubricating oil trapping space to flow downward in the circumferential direction, and a holding mechanism for restricting axial movement of the separating/guiding wall, are provided in relation to spline fitting portions formed on the inner peripheral surface of the transmission case.

### INCORPORATION BY REFERENCE

The disclosure of Japanese Patent Application No. 2009-002491 filed on Jan. 8, 2009 including the specification, drawings and abstract is incorporated herein by reference in its entirety.

### BACKGROUND OF THE INVENTION

1. Field of the Invention

The invention relates to an automatic transmission installed in a vehicle.

2. Description of the Related Art

With regard to a multiple disc clutch used in an automatic transmission for an automobile, Japanese Patent Application Publication No. 10-252777 (JP-A-10-252777), for example, describes the following constitution with which lubricating oil supplied to an inner side of a cylindrical member provided on an inner peripheral side of a multiple disc clutch can be supplied efficiently to a surface of a friction disc by means of a simple structure.

A multiple disc clutch includes an input unit assembly, an output member, first and second friction discs, a pressure plate, a return spring, and a spring holding member. The input unit assembly includes a first cylinder portion. The output member is disposed to be free to rotate relative to the input unit assembly and provided with a second cylinder portion that is disposed concentrically with an inner peripheral side of the first cylinder portion and formed with a hole that penetrates in a radial direction. The first and second friction discs are respectively engaged to the first and second cylinder portions to be capable of rotating relative thereto and free to move in an axial direction, and are disposed alternately with the first and second cylinder portions in the axial direction. The spring holding member includes a spring receiving portion that supports the return spring and a guide portion that guides lubricating oil to an inner peripheral side of the second cylinder portion.

Incidentally, to improve the fuel efficiency of a vehicle by improving the transmission efficiency of a transmission, it is essential to achieve an improvement in mechanical efficiency, or in other words a reduction in drag, and in an automatic transmission, drag in a brake unit has a particularly large effect.

The reason for this is that the brake unit employs a wet clutch which actively immerses itself in oil in order to secure wear resistance and generate appropriate friction torque, but when the amount of lubricating oil flowing into this part is excessive, drag torque is generated due to the viscous shear of the lubricating oil, even when the brake is released. As a result, the mechanical efficiency of the transmission deteriorates.

### SUMMARY OF THE INVENTION

The invention has been designed in consideration of the technical problems described above, and an object thereof is to provide an automatic transmission with which the effects of drag in a brake unit can be reduced, leading to an improvement in transmission efficiency.

An automatic transmission according to the invention includes: a clutch configured to have a frictional engagement element constituted by a plurality of outer clutch plates and a plurality of inner clutch plates disposed between the respective outer clutch plates; a clutch drum that is configured to support the frictional engagement element of the clutch; a piston configured to be on the clutch side of the clutch drum such that a pressing member provided on a tip end portion thereof presses the frictional engagement element of the clutch; a brake configured to have a frictional engagement element constituted by a plurality of outer brake plates and a plurality of inner brake plates disposed between the respective outer brake plates; a transmission case which houses the clutch, the clutch drum, the piston and the brake; a separating/guiding wall that is provided in a circumferential direction of the clutch drum, wherein a surplus lubricating oil trapping space for trapping surplus lubricating oil that gathers on the brake is formed between an inner peripheral surface of the transmission case and the separating/guiding wall, and the trapped surplus lubricating oil guided thereby is guided into the surplus lubricating oil trapping space to flow downward in the circumferential direction of the separating/guiding wall; and a holding mechanism configured to be housed in the transmission case and to restrict axial movement of the separating/guiding wall, wherein the clutch drum, the clutch, and the brake are arranged in sequence in an interior space formed by joining the transmission case to a rear case in an axial direction from the rear case side. Here, the holding mechanism may be configured to restrict axial and rotational movement of the separating/guiding wall.

In this constitution, surplus lubricating oil discharged from the clutch gathers in the brake. The surplus lubricating oil that gathers in the brake is guided to and trapped in the surplus lubricating oil trapping space defined by the inner peripheral surface of the transmission case and the separating/guiding wall, which is subject to axial or axial and rotational movement restriction by the holding mechanism. The surplus lubricating oil trapped in the trapping space then flows downward in the circumferential direction. Thus, contact between the surplus lubricating oil and the rotating piston, clutch drum and clutch is avoided, leading to a reduction in agitation loss.

Further, the separating/guiding wall is preferably configured to impinge on a spline provided on the inner peripheral surface of the transmission case, and the holding mechanism preferably includes a rib provided on an inner peripheral surface of the rear case and a spring interposed between the rib and the separating/guiding wall.

Further, the separating/guiding wall preferably includes a bottom wall portion, a side wall portion that stands upright from a rear case side end portion of the bottom wall portion, and a flange portion that projects to the rear case side from a free end portion of the side wall portion, and the spring preferably provides a spring action by partially deforming the flange portion into a predetermined shape in a diametrical direction.

Further, a one-way clutch, an outer race of which is spline-fitted to the inner peripheral surface of the transmission case together with the outer brake plates, is preferably further provided, the separating/guiding wall preferably includes a bottom wall portion, a side wall portion that stands upright from a rear case side end portion of the bottom wall portion, and an insertion piece that extends toward the one-way clutch from a free end portion of the side wall portion and is inserted into the outer race of the one-way clutch, the holding mechanism is preferably provided with a spring action by a first bent portion formed by bending a free end portion of the insertion piece in an inner diameter direction and a second bent portion formed by bending the insertion piece into a predetermined shape in the inner diameter direction such that a fitting space is formed in a position removed from the first bent portion, and the holding mechanism is preferably configured to double as a holding mechanism of the one-way clutch by embedding the fitting space formed between the first and second bent portions in the outer race of the one-way clutch.

Incidentally, it is necessary to prevent backlash (backflow) from lubricating oil that flies from first and second clutches due to high-speed rotation thereof.

Therefore, in the automatic transmission, the separating/guiding wall preferably includes a bottom wall portion and a side wall portion that stands upright from a rear case side end portion of the bottom wall portion, a plurality of notches are preferably provided in the bottom wall portion, and respective side edge portions of the notches are preferably cut and raised on an outer diameter side to form grooves.

According to the invention, an automatic transmission with which the effects of drag in a brake unit can be reduced, leading to an improvement in transmission efficiency, can be provided.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a skeleton diagram showing an automatic transmission according to a first embodiment of the invention;

FIG. 2 is an engagement table illustrating clutch and brake engagement operations for establishing respective gear positions of the automatic transmission;

FIG. 3 is a longitudinal sectional view showing main parts of the automatic transmission shown in FIG. 1;

FIG. 4 is a partially cut-away perspective view showing the constitution of a separating/guiding wall;

FIG. 5 is a sectional view taken along an A-A line in FIG. 4;

FIG. 6 is a longitudinal sectional view showing main parts of an automatic transmission according to a second embodiment of the invention;

FIG. 7 is a longitudinal sectional view showing main parts of an automatic transmission according to a third embodiment of the invention;

FIG. 8 is a longitudinal sectional view showing main parts of an automatic transmission according to a fourth embodiment of the invention;

FIG. 9 is a longitudinal sectional view showing main parts of an automatic transmission according to a fifth embodiment of the invention;

FIG. 10 is a longitudinal sectional view showing main parts of an automatic transmission according to a sixth embodiment of the invention;

FIG. 11 is a partially cut-away perspective view showing the constitution of a separating/guiding wall; and

FIG. 12 is a sectional view taken along a B-B line in FIG. 11.

### DETAILED DESCRIPTION OF EMBODIMENTS

Embodiments of the invention will be described in detail below on the basis of the attached drawings.

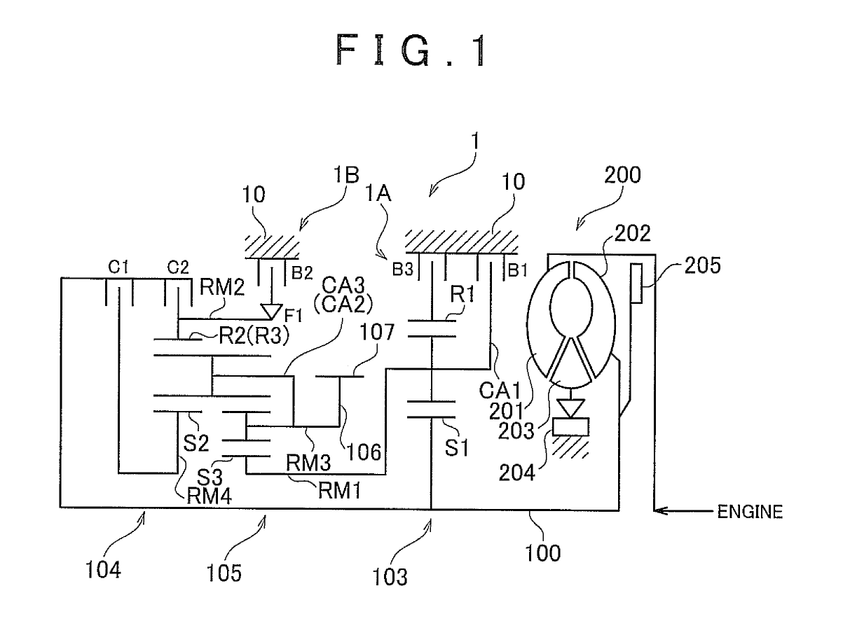

First, a first embodiment will be described. FIG. 1 is a skeleton diagram showing an automatic transmission 1 according to the first embodiment of the invention.

The automatic transmission 1 according to this embodiment is installed in a front engine/front drive (FF) vehicle and provided with a torque converter 200.

The torque converter 200 includes an input shaft-side pump impeller 201, an output shaft-side turbine runner 202, a stator 203 that possesses a torque amplification function, and a one-way clutch 204, and executes power transmission between the pump impeller 201 and the turbine runner 202 via a fluid.

The torque converter 200 is provided with a lockup clutch 205 that sets an input side and an output side in a directly connected state, and when the lockup clutch 205 is fully engaged, the pump impeller 201 and turbine runner 202 rotate integrally. Further, when the lockup clutch 205 is engaged in a predetermined slip state, the turbine runner 202 rotates so as to follow the pump impeller 201 at a predetermined slip amount during driving.

The automatic transmission 1 is a planetary gear type multistage transmission in which a first shift unit 1A constituted mainly by a single pinion type first planetary gear device 103 and a second shift unit 1B constituted mainly by a single pinion type second planetary gear device 104 and a double pinion type third planetary gear device 105 are disposed coaxially and rotation of an input shaft 100 is shifted, transmitted to an output shaft 106, and output from an output gear 107.

The output gear 107 is coupled to a differential gear device installed in the vehicle either directly or via a countershaft.

The first planetary gear device 103 constituting the first shift unit 1A includes three rotary elements, namely a sun gear S1, a carrier CA1, and a ring gear R1, wherein the sun gear S1 is coupled to the input shaft 100. Further, the ring gear R1 is fixed to a housing case 10 via a third brake B3 such that the sun gear S1 is rotated at a reduced speed relative to the input shaft 100 using the carrier CA1 as an intermediate output member.

The second and third planetary gear devices 104, 105 constituting the second shift unit 1B are partially coupled to each other such that four rotary elements RM1, RM2, RM3, RM4 are formed.

More specifically, the first rotary element RM1 is constituted by a sun gear S3 of the third planetary gear device 105, the second rotary element RM2 is formed by coupling a ring gear R2 of the second planetary gear device 104 and a ring gear R3 of the third planetary gear device 105 to each other, the third rotary element RM3 is formed by coupling a carrier CA2 of the second planetary gear device 104 and a carrier CA3 of the third planetary gear device 105 to each other, and the fourth rotary element RM4 is constituted by a sun gear S2 of the second planetary gear device 104.

In the second and third planetary gear devices 104, 105, the carriers CA2, CA3 and the ring gears R2, R3 are respectively constituted by shared members. Moreover, a pinion gear of the second planetary gear device 104 doubles as a second pinion gear of the third planetary gear device 105 to form a Ravigneaux type planetary gear train.

The first rotary element RM1 (the sun gear S3) is coupled integrally to the carrier CA1 of the first planetary gear device 103, which serves as an intermediate output member, and coupled selectively to the housing case 10 by the first brake B1, whereby rotation thereof is stopped.

The second rotary element RM2 (the ring gears R2, R3) is coupled selectively to the input shaft 100 via a second clutch C2 and coupled selectively to the housing case 10 via a one-way clutch F1 and a second brake B2, whereby rotation thereof is stopped.

The third rotary element RM3 (the carriers CA2, CA3) is coupled integrally to the output shaft 106.

The fourth rotary element RM4 (the sun gear S2) is coupled selectively to the input shaft 100 via a first clutch C1.

In the automatic transmission 1 described above, a gear position is set by engaging or disengaging the first clutch C1, second clutch C2, first brake B1, second brake B2, third brake B3, one-way clutch F1, and other frictional engagement elements in predetermined states.

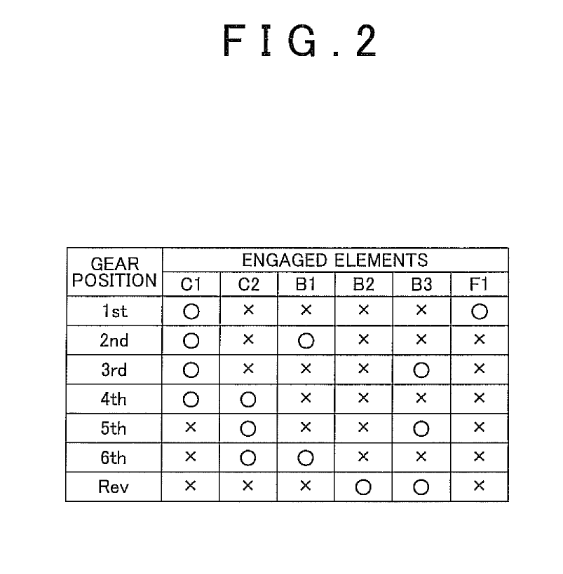

FIG. 2 is an engagement table illustrating clutch and brake engagement operations for establishing respective gear positions of the automatic transmission 1, in which circles denote engagement and crosses denote disengagement.

Referring to FIG. 2, in the automatic transmission 1, a first forward speed (1^{st}) is established by engaging the first clutch C1, and in the first speed, the one-way clutch F1 is engaged. A second forward speed (2^{nd}) is established by engaging the first clutch C1 and the first brake B1. A third forward speed (3^{rd}) is established by engaging the first clutch C1 and the third brake B3. A fourth forward speed (4^{th}) is established by engaging the first and second clutches C1, C2. A fifth forward speed (5^{th}) is established by engaging the second clutch C2 and the third brake B3. A sixth forward speed (6^{th}) is established by engaging the second clutch C2 and the first brake B1. Meanwhile, a reverse speed (Rev) is established by engaging the second and third brakes B2, B3.

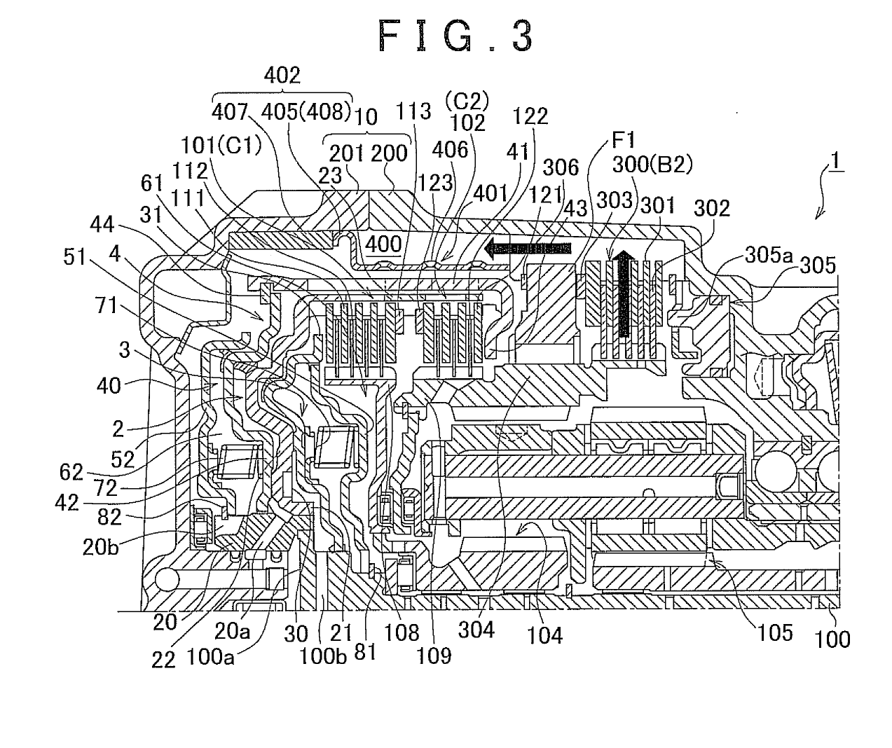

FIG. 3 is a longitudinal sectional view showing main parts of the automatic transmission 1 shown in FIG. 1. The automatic transmission 1 includes the input shaft 100, which is supported via a bearing to be capable of rotating relative to the housing case 10, the single pinion type second planetary gear device 104, the double pinion type third planetary gear device 105, the first and second clutches C1, C2, the second brake B2, the one-way clutch F1, a clutch drum 2, first and second pistons 3, 4, and so on.

The housing case 10 includes a transmission case 200 and a rear case 201, and in an interior space formed by joining the transmission case 200 to the rear case 201, the clutch drum 2, the first clutch C1, the second clutch C2, the one-way clutch F1 and the second brake B2 are arranged in sequence in an axial direction from the rear case 201 side.

The input shaft 100 is formed with a flange 100a extending perpendicular to an axial center thereof. A ring-shaped base member 20 is disposed on an outer peripheral edge of the flange 100a.

The base member 20 is supported by the rear case 201 to be capable of rotating relative thereto.

The clutch drum 2 is used to support respective frictional engagement elements 101, 102 of the first and second clutches C1, C2, and is constituted by a hub portion 21 externally attached to the base member 20, a ring-shaped side wall 22 extending in a radial direction from the hub portion 21, and a cylindrical cylinder portion 23 extending in the axial direction from an outer peripheral edge of the side wall 22.

The hub portion 21 of the clutch drum 2 is fixed to the base member 20 by welding or the like. The base member 20 is fixed to the flange 100a of the input shaft 100 by welding or the like. Accordingly, the clutch drum 2 rotates integrally with the input shaft 100.

The frictional engagement element 101 serving as a constitutional member of the first clutch C1 and the frictional engagement element 102 serving as a constitutional member of the second clutch C2 are disposed inside the cylinder portion 23 of the clutch drum 2.

The frictional engagement element 101 serving as a constitutional member of the first clutch C1 is constituted by a plurality of outer clutch plates 111 and a plurality of inner clutch plates 112 disposed between the respective outer clutch plates 111.

The outer clutch plates 111 constituting the frictional engagement element 101 of the first clutch C1 are spline-fitted to an inner peripheral surface of the cylinder portion 23 of the clutch drum 2, while the inner clutch plates 112 are spline-fitted to an outer peripheral surface of a first clutch hub 108. Movement (axial movement) of the frictional engagement element 101 to the side of the frictional engagement element 102 of the second clutch C2 is restricted by a snap ring 113 fixed to the cylinder portion 23 of the clutch drum 2.

Similarly to the frictional engagement element 101 of the first clutch C1, the frictional engagement element 102 serving as a constitutional member of the second clutch C2 is constituted by a plurality of outer clutch plates 121 and a plurality of inner clutch plates 122 disposed between the respective outer clutch plates 121.

The outer clutch plates 121 constituting the frictional engagement element 102 of the second clutch C2 are spline-fitted to the inner peripheral surface of the cylinder portion 23 of the clutch drum 2, while the inner clutch plates 122 are spline-fitted to an outer peripheral surface of a second clutch hub 109. Movement (axial movement) of the frictional engagement element 102 to the side of the frictional engagement element 101 of the first clutch C1 is restricted by a snap ring 123 fixed to the cylinder portion 23 of the clutch drum 2.

The first piston 3 is disposed on an inner peripheral side (the first clutch C1 side) of the clutch drum 2 so as to be covered by the clutch drum 2.

The first piston 3 is embedded in the input shaft 100 to be free to slide relative to the input shaft 100 in the axial direction. The first piston 3 is a substantially disc-shaped member in which a pressing member 31 is formed integrally with an outer peripheral edge thereof. The first piston 3 rotates integrally with the clutch drum 2.

A first oil chamber 30 is formed between the first piston 3 described above and the side wall 22 of the clutch drum 2, and when automatic transmission fluid (ATF) (working oil) is supplied into the first oil chamber 30 through an oil hole 100b formed in the input shaft 100, the first piston 3 moves in a direction heading away from the clutch drum 2 (toward the frictional engagement element 101 of the first clutch C1) such that the pressing member 31 provided on a tip end portion of the first piston 3 presses the frictional engagement element 101 of the first clutch C1. When the frictional engagement element 101 of the first clutch C1 is pressed in this manner, the outer clutch plates 111 and inner clutch plates 112 constituting the frictional engagement element 101 engage with each other. In other words, the first clutch C1 enters an engaged state.

A ring-shaped balancer 51 is disposed on a front surface side (the first clutch C1 side) of the first piston 3. The balancer 51 is externally fitted to the input shaft 100, and movement thereof in a direction heading away from the first piston 3 is restricted by a snap ring 81 fixed to the input shaft 100.

A return spring 71 is disposed between the balancer 51 and the first piston 3, and the first piston 3 is biased in a direction heading away from the balancer 51 (toward the clutch drum 2) by an elastic force of the return spring 71.

A cancel chamber 61 that cancels a centrifugal oil pressure of the first oil chamber 30 in the first piston 3 is formed between the balancer 51 described above and the first clutch hub 108. The cancel chamber 61 communicates with a space formed between the balancer 51 and the first piston 3 via a cutout formed in an inner peripheral portion of the balancer 51.

The second piston 4 is disposed on the opposite side of the clutch drum 2 to the first piston 3.

The second piston 4 is embedded in the base member 20 to be free to slide relative to the base member 20 in the axial direction. Similarly to the first piston 3, the second piston 4 rotates integrally with the clutch drum 2.

Further, the second piston 4 is constituted by a cylindrical cylinder member 41 covering an outer peripheral portion of the clutch drum 2, a ring-shaped side wall 42 embedded into one end portion of the cylinder member 41, and a snap ring 44 that fixes the side wall 42 to the cylinder member 41. A pressing member 43 projecting inwardly (toward a rotary center side) is formed integrally with a tip end (other end) of the cylinder member 41.

A second oil chamber 40 is formed between the side wall 42 of the second piston 4 described above and the side wall 22 of the clutch drum 2, and when ATF (working oil) is supplied into the second oil chamber 40 through an oil hole 20a formed in the base member 20, the second piston 4 moves in a direction heading away from the clutch drum 2 (in an opposite direction to the first piston 3) such that the pressing member 43 provided on the tip end portion of the second piston 4 presses the frictional engagement element 102 of the second clutch C2. When the frictional engagement element 102 of the second clutch C2 is pressed in this manner, the outer clutch plates 121 and inner clutch plates 122 constituting the frictional engagement element 102 engage with each other. In other words, the second clutch C2 enters an engaged state.

A ring-shaped balancer 52 is disposed on a back surface side (the opposite side of the second oil chamber 40) of the second piston 4. The balancer 52 is externally fitted to the base member 20, and movement thereof in a direction heading away from the second piston 4 is restricted by a snap ring 82 fixed to the base member 20.

A return spring 72 is disposed between the balancer 52 and the side wall 42 of the second piston 4, and the second piston 4 is biased in a direction heading away from the balancer 52 (toward the clutch drum 2) by an elastic force of the return spring 72.

A cancel chamber 62 that cancels a centrifugal oil pressure of the second oil chamber 40 is formed between the balancer 52 described above and the side wall 42 of the second piston 4. The cancel chamber 62 communicates with a space formed on a back surface side of the balancer 52 via a plurality of grooves 20b formed in an outer periphery of the base member 20.

The second brake B2 includes a frictional engagement element 300 constituted by a plurality of outer brake plates 301 and a plurality of inner brake plates 302 disposed between the respective outer brake plates 301. Movement (axial movement) of the frictional engagement element 300 to the side of the one-way clutch F1 is restricted by a snap ring 303 disposed between the frictional engagement element 300 and the one-way clutch F1.

The outer brake plates 301 are spline-fitted to an inner peripheral surface of the transmission case 200, while the inner brake plates 302 are spline-fitted to an end portion outer peripheral surface of a Ravigneaux ring gear 304.

A piston 305 that presses the frictional engagement element 300 serving as a constitutional member of the second brake B2 using a pressing member 305a provided on a tip end portion thereof in order to engage the outer brake plates 301 and inner brake plates 302 constituting the frictional engagement element 300 with each other is provided on a back surface side (the torque converter 200 side) of the frictional engagement element 300.

An outer race of the one-way clutch F1 is spline-fitted to the inner peripheral surface of the transmission case 200 together with the outer brake plates 301 of the second brake B2. Movement (axial movement) of the one-way clutch F1 to the second clutch C2 side is restricted by a snap ring 306.

A separating/guiding wall 401 that is provided in a circumferential direction so as to define a surplus lubricating oil trapping space 400 for trapping surplus lubricating oil that gathers on the inner peripheral surface of the transmission case 200 and in the second brake B2, and causes trapped surplus lubricating oil guided thereby into the surplus lubricating oil trapping space 400 to flow downward in the circumferential direction, and a holding mechanism 402 for restricting axial and rotational movement of the separating/guiding wall 401, are provided in the automatic transmission 1 in relation to the splines on the inner peripheral surface of the transmission case 200. Under normal circumstances, the separating/guiding wall 401 is not subjected to a force that encourages it to move in a rotational direction, but even when an extraordinary external force generated through vibration or the like acts on the separating/guiding wall 401 to encourage it to move in the rotational direction, rotational movement is restricted by a frictional force generated between an end portion of the holding mechanism 402 and an end portion of a rib 407 by a spring 408 of the holding mechanism 402. More specifically, the separating/guiding wall 401 impinges on the splines provided on the inner peripheral surface of the transmission case 200 such that axial and rotational movement thereof is restricted by the holding mechanism 402.

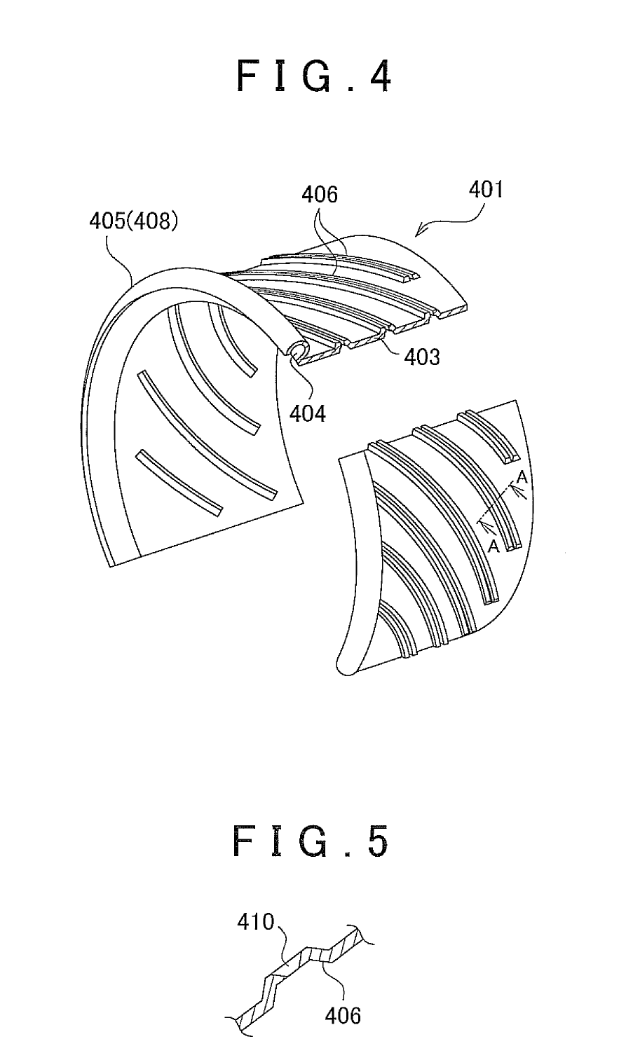

FIG. 4 is a partially cut-away perspective view showing the constitution of the separating/guiding wall 401, and FIG. 5 is a sectional view taken along an A-A line in FIG. 4.

Referring to FIG. 4, the separating/guiding wall 401 is manufactured using a metal plate possessing elasticity, such as cold-rolled steel plate or spring steel, and is constituted by a bottom wall portion 403, a side wall portion 404 that stands upright from a rear case 201 side end portion of the bottom wall portion 403, and a flange portion 405 that projects to the rear case 201 side from a free end portion of the side wall portion 404. In particular, grooves 406 for preventing backlash (backflow) from the lubricating oil that flies from the first and second clutches C1, C2 rotating at high speed are formed in the bottom wall portion 403. The grooves 406 are formed by providing a plurality of notches 410 that intersect the axial direction diagonally and cutting and raising respective side edge portions of the notches 410 to an outer diameter side. As shown in FIG. 5, a cross-sectional shape of the groove 406 is formed such that the grooves 406 serve as splines capable of carrying an oil flow and guiding the oil flow rearward, thereby preventing leakage of the lubricating oil.

As shown in FIGS. 3 and 4, the holding mechanism 402 includes the rib 407, which is provided in the circumferential direction on the inner peripheral surface of the rear case 201, and the spring 408, which is interposed between the rib 407 and the side wall portion 404 of the separating/guiding wall 401. In particular, the spring 408 is provided with a spring action by deforming a tip end portion of the flange portion 405 of the separating/guiding wall 401 in an outer diameter direction into a substantially inverted U shape through pressing or the like.

In the constitution described above, surplus lubricating oil discharged from the first and second clutches C1, C2 gathers in the second brake B2. As shown by arrows in FIG. 3, the surplus lubricating oil that gathers in the second brake B2 is guided to and trapped in the surplus lubricating oil trapping space 400 defined by the inner peripheral surface of the transmission case 200 and the separating/guiding wall 401, which impinges on the splines on the inner peripheral surface of the transmission case 200 such that axial and rotational movement thereof is restricted by the holding mechanism 402. The surplus lubricating oil trapped in the trapping space 400 then flows downward in the circumferential direction along the bottom wall portion 403 of the separating/guiding wall 401. Thus, contact between the surplus lubricating oil and the rotating first and second pistons 3, 4, clutch drum 2, and first and second clutches C1, C2 is avoided, leading to a reduction in agitation loss.

Further, although lubricating oil flies from the first and second clutches C1, C2 rotating at high speed, the grooves 406 are formed in the bottom wall portion 403 of the separating/guiding wall 401 as splines capable of carrying an oil flow and guiding the oil flow rearward by cutting and raising the two side edge portions of the plurality of notches 410 that intersect the axial direction diagonally on the outer diameter side, thereby ensuring that the lubricating oil does not leak, and as a result, the lubricating oil that flies from the first and second clutches C1, C2 flows into the trapping space 400 of the separating/guiding wall 401 from the grooves 406. Hence, backlash (backflow) from the lubricating oil that flies from the first and second clutches C1, C2 can be prevented.

As is evident from the above description, according to this embodiment, the effect of drag in the second brake B2 is reduced, leading to an improvement in the mechanical efficiency of the automatic transmission 1 and a resulting improvement in the fuel efficiency of the automatic transmission 1.

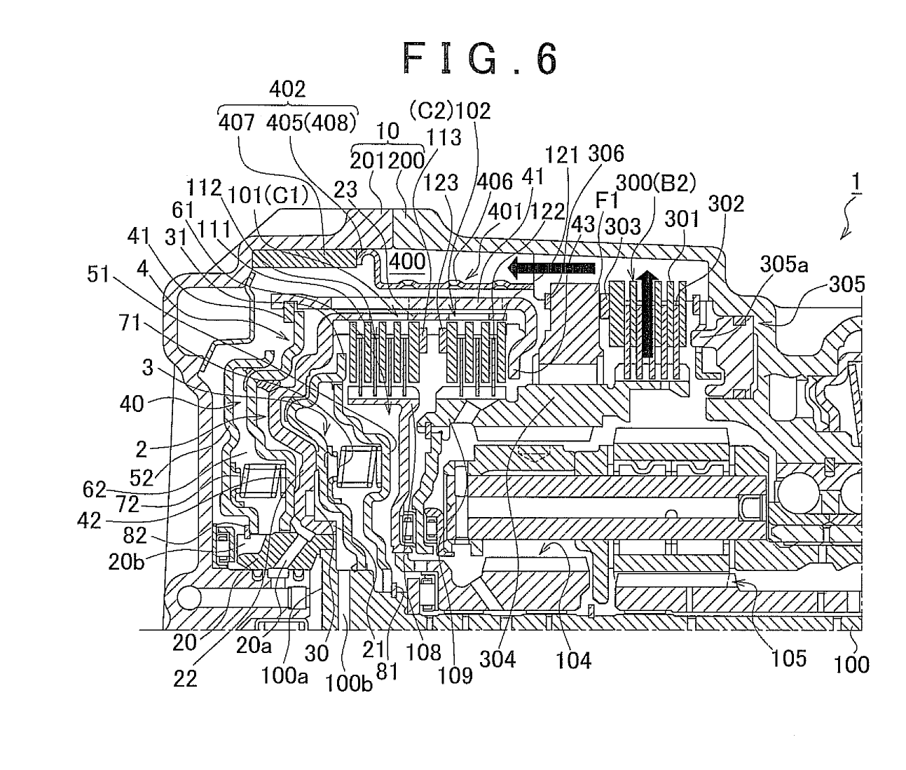

Next, a second embodiment will be described. FIG. 6 is a longitudinal sectional view showing main parts of the automatic transmission 1 according to the second embodiment of the invention. Referring to FIG. 6, a feature of the automatic transmission 1 according to this embodiment is that when the spring 408 of the holding mechanism 402 is provided with a spring action by deforming the tip end portion of the flange portion 405 of the separating/guiding wall 401 in the outer diameter direction into a substantially inverted U shape through pressing or the like, a curved portion serving as a base portion of the spring 408 is formed in a large rounded shape that appears angular. All other constitutions are identical to the first embodiment.

According to this embodiment, the following actions and effects are obtained in addition to the actions and effects of the first embodiment.

By forming the curved portion serving as the base portion of the spring 408 of the holding mechanism 402 in a large rounded shape, cracks and so on are less likely to occur in the curved portion, leading to an increase in the durability of the spring 408 of the holding mechanism 402.

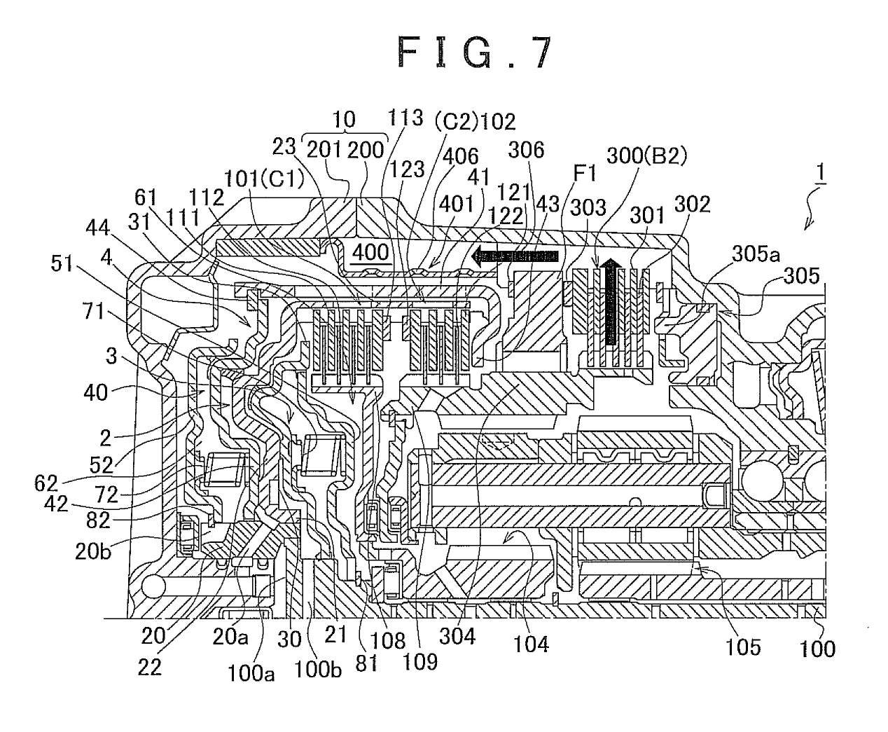

Next, a third embodiment will be described. FIG. 7 is a longitudinal sectional view showing main parts of the automatic transmission 1 according to the third embodiment of the invention. Referring to FIG. 7, a feature of the automatic transmission 1 according to this embodiment is that the spring 408 of the holding mechanism 402 is provided with a spring action by deforming the tip end portion of the flange portion 405 of the separating/guiding wall 401 into a substantially inverted V shape in an inner diameter direction through pressing or the like. All other constitutions and the actions and effects of this embodiment are identical to the first embodiment.

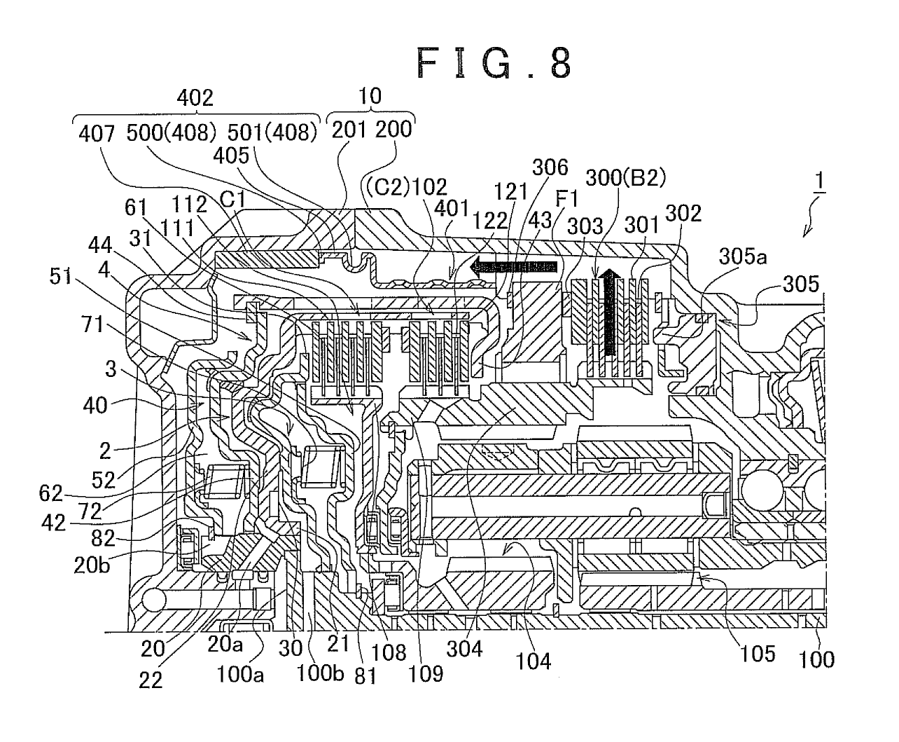

Next, a fourth embodiment will be described. FIG. 8 is a longitudinal sectional view showing main parts of the automatic transmission 1 according to the fourth embodiment of the invention. Referring to FIG. 8, a feature of the automatic transmission 1 according to this embodiment is that a first spring action portion 500, in which a spring action is provided by deforming the tip end portion of the flange portion 405 of the separating/guiding wall 401 in the inner diameter direction into a substantially inverted L shape through pressing or the like, and a second spring action portion 501, in which a spring action is provided by deforming a base portion of the flange portion 405 of the separating/guiding wall 401 toward the inner diameter side into an inverted U shape through pressing or the like, are provided as the spring 408 of the holding mechanism 402. All other constitutions are identical to the first embodiment.

According to this embodiment, the following actions and effects are obtained in addition to the actions and effects of the first embodiment.

By providing the first spring action portion 500 on the tip end portion of the flange portion 405 of the separating/guiding wall 401 and providing the second spring action portion 501 on the base portion of the flange portion 405 of the separating/guiding wall 401 as the spring 408 of the holding mechanism 402, the elastic force of the spring 408 of the holding mechanism 402 is enhanced. As a result, the force applied by the holding mechanism 402 to restrict axial movement of the separating/guiding wall 401 is strengthened.

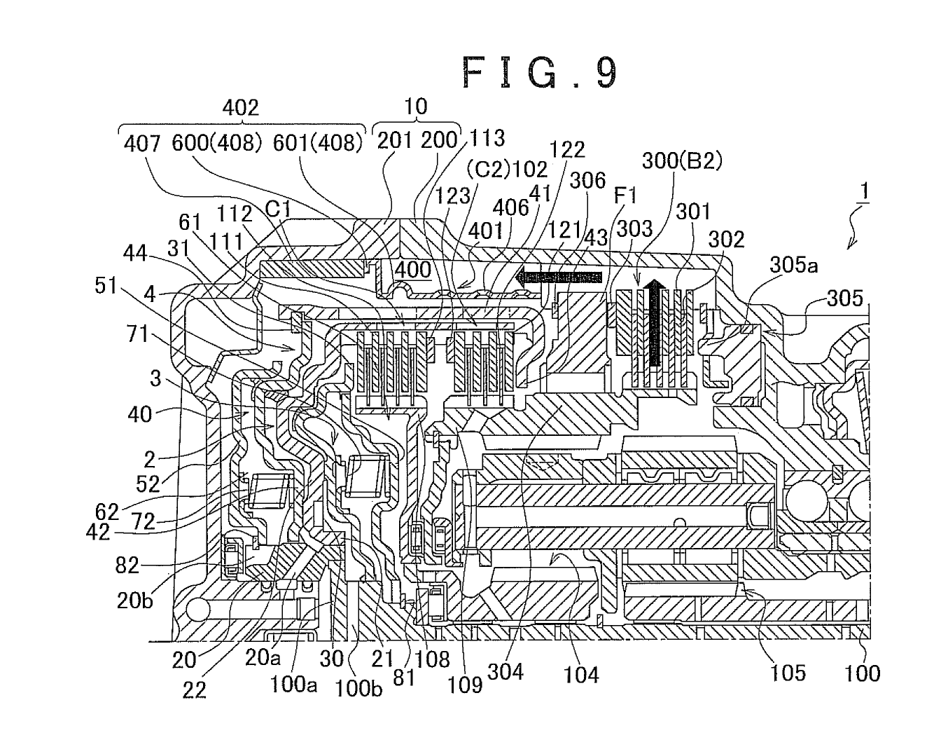

Next, a fifth embodiment will be described. FIG. 9 is a longitudinal sectional view showing main parts of the automatic transmission 1 according to the fifth embodiment of the invention. Referring to FIG. 9, a feature of the automatic transmission 1 according to this embodiment is that first and second spring action portions 600, 601, in which a spring action is provided by deforming the tip end portion of the flange portion 405 of the separating/guiding wall 401 in the outer diameter direction into a substantially inverted U shape through pressing or the like, are provided continuously as the spring 408 of the holding mechanism 402. All other constitutions and the actions and effects of this embodiment are identical to the fourth embodiment.

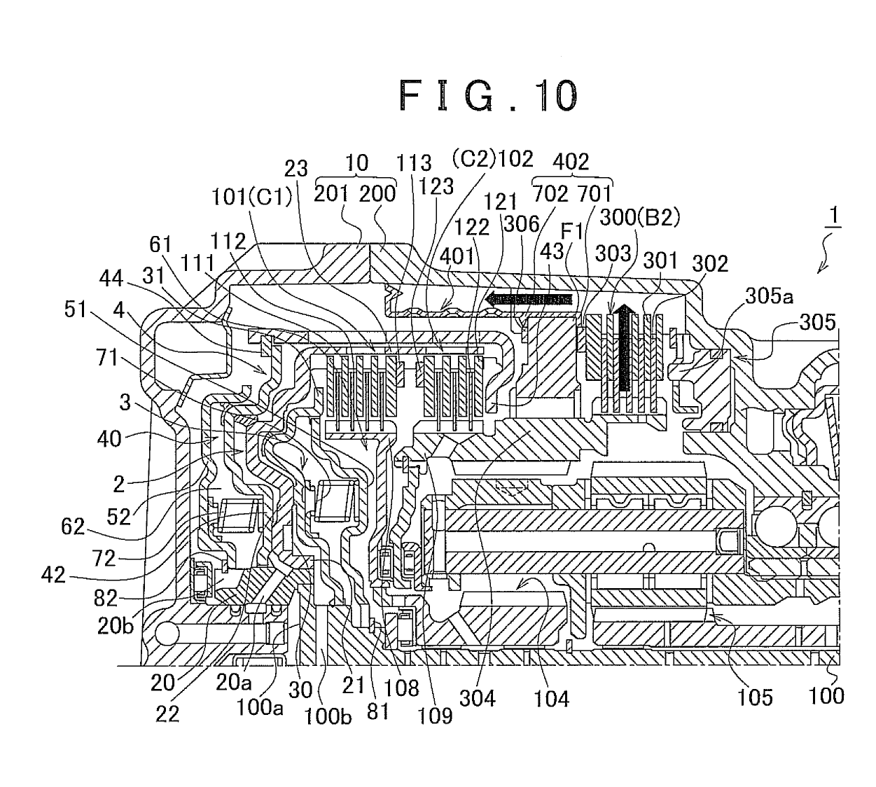

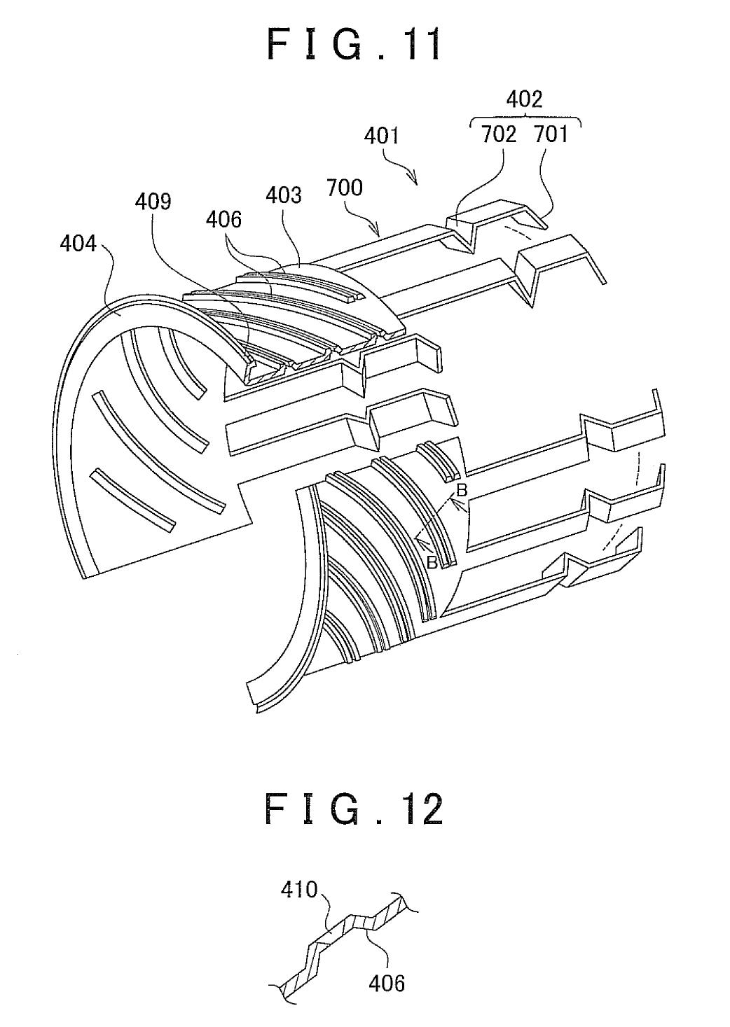

Next, a sixth embodiment will be described. FIG. 10 is a longitudinal sectional view showing main parts of the automatic transmission 1 according to a sixth embodiment of the invention. FIG. 11 is a partially cut-away perspective view showing the constitution of the separating/guiding wall 401. FIG. 12 is a sectional view taken along a B-B line in FIG. 11.

Referring to FIGS. 9 to 12, in the automatic transmission 1 according to this embodiment, the separating/guiding wall 401 is constituted by the bottom wall portion 403, the side wall portion 404, and an insertion piece 700 that extends toward the one-way clutch F1 from a free end portion of the side wall portion 404 and is inserted into a trough portion in the outer race of the one-way clutch F1. Note that the reference numeral 700 appears only in FIG. 10.

Further, in the holding mechanism 402, the spring action is provided by a first bent portion 701 formed by bending the free end portion of the insertion piece 700 of the separating/guiding wall 401 in the inner diameter direction, and a second bent portion 702 formed by bending the insertion piece 700 substantially into a V shape in the inner diameter direction such that a fitting space is formed in a position removed from the first bent portion 701. By embedding the fitting space formed between the first and second bent portions 701, 702 in the trough portion in the outer race of the one-way clutch F1, the holding mechanism 402 doubles as a holding mechanism for the one-way clutch F1. In other words, the holding mechanism 402 is formed such that the tip end portion of the insertion piece 700 of the separating/guiding wall 401 is enveloped by the one-way clutch F1, thereby restricting axial and rotational movement of the separating/guiding wall 401.

Furthermore, in the automatic transmission 1, a rattle absorbing mechanism 409 is formed by bending the tip end portion of the side wall portion 404 of the separating/guiding wall 401 substantially into a V shape in the axial direction (the opposite side to the rear case 201) so that it contacts the inner peripheral surface of the transmission case 200. Note that all other constitutions are identical to the first embodiment.

According to this embodiment, the following actions and effects are obtained in addition to the actions and effects of the first embodiment.

The holding mechanism 402 is made to double as the holding mechanism of the one-way clutch F1 by bending the free end portion of the insertion piece 700 of the separating/guiding wall 401, which is provided with a spring action, in the inner diameter direction to form the first and second bent portions 701, 702 and embedding the fitting space formed between the first and second bent portions 701, 702 in the trough portion in the outer race of the one-way clutch F1, and axial and rotational movement of the separating/guiding wall 401 is restricted by ensuring that the tip end portion of the insertion piece 700 of the separating/guiding wall 401 is enveloped by the one-way clutch F1. Hence, the constitution of the holding mechanism 402 is simplified.

Further, the rattle absorbing mechanism 409 is provided on the tip end portion of the side wall portion 404 of the separating/guiding wall 401, and therefore wear and damage to the separating/guiding wall 401 and peripheral members thereof due to vibration of the automatic transmission 1 and so on, as well as abnormal noises, can be prevented.

Note that the invention is not limited to the above embodiments. In the first to fifth embodiments, examples in which the spring constituting the holding mechanism is formed integrally with the separating/guiding wall were described. However, the invention is not limited to this constitution, and the spring constituting the holding mechanism may be formed separately to the separating/guiding wall and interposed between the rib provided on the inner peripheral surface of the rear case and the side wall portion of the separating/guiding wall.

Further, in the example described in the sixth embodiment, the holding mechanism is constituted to restrict axial and rotation movement of the separating/guiding wall by bending the free end portion of the insertion piece of the separating/guiding wall, which is provided with a spring action, in the inner diameter direction to form the first and second bent portions and embedding the fitting space formed between the first and second bent portions in the trough portion in the outer race of the one-way clutch, thereby ensuring that the tip end portion of the insertion piece of the separating/guiding wall is enveloped by the one-way clutch. However, the invention is not limited to this constitution, and the holding mechanism may be constituted to restrict axial and rotation movement of the separating/guiding wall by bending the free end portion of the insertion piece of the separating/guiding wall, which is provided with a spring action, in the inner diameter direction to form the first and second bent portions and embedding the fitting space formed between the first and second bent portions in an apex portion of the outer race of the one-way clutch, thereby ensuring that the tip end portion of the insertion piece of the separating/guiding wall is enveloped by the one-way clutch.

In addition, various design modifications and amendments may of course be applied within the scope of the claims attached to this specification.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the scope of the invention.

What is claimed is:

1. An automatic transmission comprising:
a clutch that is configured to have a frictional engagement element constituted by a plurality of outer clutch plates and a plurality of inner clutch plates disposed between the respective outer clutch plates;
a clutch drum that is configured to support the frictional engagement element of the clutch;
a piston that is configured to be on the clutch side of the clutch drum such that a pressing member provided on a tip end portion thereof presses the frictional engagement element of the clutch;
a brake that is configured to have a frictional engagement element constituted by a plurality of outer brake plates and a plurality of inner brake plates disposed between the respective outer brake plates;
a transmission case which houses the clutch, the clutch drum, the piston and the brake;
a separating/guiding wall that is provided in a circumferential direction of the clutch drum, wherein a surplus lubricating oil trapping space for trapping surplus lubricating oil that gathers on the brake is formed between an inner peripheral surface of the transmission case and the separating/guiding wall, and the trapped surplus lubricating oil guided thereby is guided into the surplus lubricating oil trapping space to flow downward in the circumferential direction of the separating/guiding wall; and
a holding mechanism that is configured to be housed in the transmission case and to restrict axial movement of the separating/guiding wall, wherein
the clutch drum, the clutch, and the brake are arranged in sequence in an interior space formed by joining the transmission case to a rear case in an axial direction from the rear case side.

2. The automatic transmission according to claim 1, wherein the holding mechanism restricts axial and rotational movement of the separating/guiding wall.

3. The automatic transmission according to claim 2, wherein the separating/guiding wall impinges on a spline provided on the inner peripheral surface of the transmission case, and the holding mechanism includes a rib provided on an inner peripheral surface of the rear case and a spring interposed between the rib and the separating/guiding wall.

4. The automatic transmission according to claim 3, wherein the separating/guiding wall includes a bottom wall portion, a side wall portion that stands upright from a rear case side end portion of the bottom wall portion, and a flange portion that projects to the rear case side from a free end portion of the side wall portion, and
the spring provides a spring action by partially deforming the flange portion into a predetermined shape in a diametrical direction.

5. The automatic transmission according to claim 4, wherein the predetermined shape is an inverted U shape inverted in an outer diameter direction of the separating/guiding wall.

6. The automatic transmission according to claim 4, wherein the predetermined shape is an inverted U shape which is inverted in an outer diameter direction of the separating/guiding wall, and in which a curved portion is nearly angular.

7. The automatic transmission according to claim 4, wherein the predetermined shape is obtained by forming a tip end portion of the flange portion into an inverted V shape inverted in an inner diameter direction of the separating/guiding wall.

8. The automatic transmission according to claim 4, wherein the predetermined shape is an inverted U shape inverted in an inner diameter direction of the separating/guiding wall.

9. The automatic transmission according to claim 4, wherein the predetermined shape is obtained by forming two inverted U shapes inverted in an outer diameter direction of the separating/guiding wall continuously in the axial direction.

10. The automatic transmission according to claim 2, wherein a one-way clutch, an outer race of which is spline-fitted to the inner peripheral surface of the transmission case together with the outer brake plates, is further provided,
the separating/guiding wall includes a bottom wall portion, a side wall portion that stands upright from a rear case side end portion of the bottom wall portion, and an insertion piece that extends toward the one-way clutch from a free end portion of the side wall portion and is inserted into the outer race of the one-way clutch,
the holding mechanism is provided with a spring action by a first bent portion formed by bending a free end portion of the insertion piece in an inner diameter direction and a second bent portion formed by bending the insertion piece into a predetermined shape in the inner diameter direction such that a fitting space is formed in a position removed from the first bent portion, and
the holding mechanism is configured to double as a holding mechanism of the one-way clutch by embedding the fitting space formed between the first and second bent portions in the outer race of the one-way clutch.

11. The automatic transmission according to claim 10, wherein the separating/guiding wall includes a rattle absorbing mechanism formed by bending the bottom wall portion into a V shape in an opposite side end portion to the rear case.

12. The automatic transmission according to claim 1, wherein the separating/guiding wall includes a bottom wall portion and a side wall portion that stands upright from a rear case side end portion of the bottom wall portion,
a plurality of notches are provided in the bottom wall portion, and
respective side edge portions of the notches are cut and raised on an outer diameter side to form grooves.
